(19) United States
(12) Patent Application Publication
(10) Pub. No.: US 2026/0257664 A1
(43) Pub. Date: Sep. 3, 2026

(54) METHOD FOR COUPLING A FIRST PARTIAL DRIVE CHAIN OF A HYBRID VEHICLE TO A SECOND PARTIAL DRIVE TRAIN, COMPUTER PROGRAM PRODUCT, AND HYBRID VEHICLE DRIVE TRAIN

(71) Applicant: Schaeffler Technologies AG & Co. KG, Herzogenaurach (DE)

(72) Inventors: Christian Weber, Achern (DE); Ulrich Neuberth, Ötigheim (DE); Marian Preisner, Bühl (DE); Raphael Künzig, Rheinstetten (DE)

(73) Assignee: Schaeffler Technologies AG & Co. KG, Herzogenaurach (DE)

(21) Appl. No.: 18/846,666

(22) PCT Filed: Feb. 27, 2023
(86) PCT No.: PCT/DE2023/100151

§ 371 Date: Sep. 13, 2024

(30) Foreign Application Priority Data
Mar. 15, 2022 (DE) 10 2022 106 001.2

(51) Int. Cl. B60W 20/40; B60W 10/06; B60W 10/08

(52) U.S. Cl. CPC B60W 20/40; B60W 10/02; B60W 10/06; B60W 10/08; B60W 20/20; B60W 2510/0208; B60W 2710/0666; B60W 2710/081; B60W 2710/083

(57) ABSTRACT

A method for coupling a first partial drive train of a hybrid vehicle having a first shaft, an internal combustion engine and a first electric machine, which can be selectively operated in generator or motor mode, to a second partial drive train of the hybrid vehicle having a second shaft and an electric drive machine. In a control or regulating step, a speed adjustment of the first shaft is carried out by acting on the speed of the first electric machine, wherein, at the same time, the torque of the internal combustion engine is changed in the same direction in order to achieve the same performance level of the first shaft before the speed adjustment. A computer program product and a hybrid vehicle drive train with a control device containing the computer program product, which is designed to bring about the method is provided.

### CROSS-REFERENCE TO RELATED APPLICATIONS

This application is the U.S. National Phase of PCT Appln. No. PCT/DE2023/100151 filed Feb. 27, 2023, which claims priority to DE 10 2022 106 001.2 filed Mar. 15, 2022, the entire disclosures of which are incorporated by reference herein.

### TECHNICAL FIELD

The disclosure relates to a method for coupling a first partial drive train of a hybrid vehicle, such as a passenger car, a truck or another commercial vehicle, having a first shaft of an internal combustion engine and a first electric machine that can be operated selectively in generator or motor mode, to a second partial drive train of the hybrid vehicle having a second shaft and an electric drive machine/second electric machine, preferably by engaging a clutch, such as a (dry/wet) friction clutch or a dog clutch.

### BACKGROUND

The disclosure is therefore in the field of vehicles with hybrid drive trains. These are formed by/comprise an e-machine, which can generally generate the drive torque, as well as another part that can be coupled to it, for example via a friction clutch, consisting of/comprising an internal combustion engine and another e-machine as well as a battery and a control device/control electronics unit. An exchange of energy can and is intended to take place between the electrical components.

To ensure that the driver of a hybrid vehicle does not notice anything when an internal combustion engine is connected, neither acoustically nor haptically, it is desirable to make the engaging process of the clutch connecting the two partial drive trains of the hybrid vehicle as smooth as possible. There is still considerable need for improvement with respect to the prior art.

### SUMMARY

It is the object of the disclosure to eliminate or at least mitigate the disadvantages from the prior art.

This is achieved according to the disclosure by a method in which, in one or more control or regulating steps, a speed adjustment is carried out, that is to say by raising or lowering the speed of the first shaft, i.e., of the first partial drive train, by acting on the speed of the first electric machine, which requires an adjustment of the torque of the first electric machine, wherein at the same time (also) a change in the same direction, that is to say raising or lowering, of the torque of the internal combustion engine is carried out in order to achieve the same performance level of the first shaft before the speed adjustment. This against the background of P=M·n.

For what is termed the parallel mode of the driving strategy, it is desirable/necessary to couple the mechanically couplable part (via a friction clutch) consisting of/comprising an internal combustion engine and an e-machine to the rest of the drive train. The focus in this case is in particular on the coupling process. The requirements for coupling the drive train are determined by the hybrid strategy and monitored by the driving strategy to ensure that all vehicle-specific constraints are met. The coupling process now is not noticeable to the driver. The coupling process is now completed as quickly as possible in order to operate the vehicle as energy-efficiently as possible.

The control and regulation strategy could also be divided into five phases:

Phase 1: A separating clutch is disengaged and a first partial drive train with an internal combustion engine and a first electric machine is decoupled from a second partial drive train with a second electric machine.

Phase 2: The speeds of the first partial drive train and the second partial drive train are synchronized at the separating clutch: If a speed of the first electric machine is greater than a speed of the second electric machine, a torque of the internal combustion engine is reduced for rapid synchronization. In the other case, the torque of the internal combustion engine is increased. The maximum and actual torques of the first electric machine and the internal combustion engine are always taken into account in order to achieve maximum power and to support or limit a speed controller of the first electric machine.

Phase 3: As soon as a slip speed between the first electric machine and the second electric machine falls below a hysteresis threshold value and the slip speed is within the hysteresis for a certain time period, the separating clutch is engaged and the torque of the first electric machine is maintained. By observing all current torques and compensating for errors via the second electric machine, the torques throughout the drive train are distributed so that the torque desired by the driver is applied to the wheels.

Phase 4 and phase 5: Phases 4 and 5 can be separate or combined. In phase 4, the torque of the first electric machine is suppressed with a limited gradient in order to control the torques only via the second electric machine. In phase 5, the torque of the internal combustion engine is transferred to a hybrid strategy so that it approaches a strategically optimal point for the entire drive train.

When calculating a target speed for synchronization, a current gradient of the speed of the second electric machine is determined.

The inventive solution to the problem could also be described as follows:

When the hybrid transmission changes state as a result of the hybrid strategy, the transition to coupling the internal combustion engine with the e-machine to the wheel is triggered in the driving strategy. A software logic then checks whether all boundary conditions for the transition (e.g., vehicle speed) are met. If this is the case, a state machine is triggered, which coordinates the coupling (hybrid transition manager).

This triggers the synchronization of the e-motor speeds to engage the clutch with almost no slip. An algorithm then checks that the speeds are synchronized. The current speed value for a specific shaft is compared with the speeds of the other shaft and the minimum of the speed difference is evaluated. This result is smoothed with another filter. As soon as synchronous speed (slip speed for a certain time period below a threshold) and the clutch are detected, the clutch is engaged. After the clutch is engaged, the torques of the two e-motors are reduced to zero or suppressed to a supporting electrically generated torque (load point shift) such that mainly the internal combustion engine provides the wheel torque. Finally, the internal combustion engine torque is transferred to the hybrid strategy and the transient process is completed.

The torque distribution software function receives the requests from the hybrid transition manager and calculates the torques and speeds for the components connected to the system.

The driver's desired torque always has priority and is adjusted. As soon as the drive train is completely coupled, a software logic ensures that the missing torque from the internal combustion engine and the first electric machine/e-machine is compensated for via the main e-machine/electric drive machine.

For the speed synchronization of the two partial drive trains, the software includes a logic that provides a speed controller to match the speeds via the first electric machine/e-machine 1. In order to accelerate the synchronous process, a software strategy has been developed that adjusts the internal combustion engine torque according to the differential speed in order to support e-machine 1. This is necessary because e-machine 1 is often operated at its limit characteristic curve in order to provide full system dynamics. With the available torque reserve, the speed could only be adjusted very slowly.

Furthermore, the wheel speed gradient can be taken into account for the target speed to couple the drive train. This provides the controller directly with a calculated speed. This has the advantage that the target speed does not always have to be adjusted as soon as the vehicle is in an acceleration or deceleration phase, thus increasing the time for the clutch engagement process.

For each hybrid transition manager request, the torque distribution provides a separately calibrated torque gradient limit. Between mode changes, the torque is blended to avoid torque jumps in the drive train. With the different gradients, for example, the synchronization process can take place very quickly and the torque overlap between the e-motor and the internal combustion engine can take place more slowly. This means that the transitions are not noticeable to the driver and the acoustics are optimized.

Advantageous embodiments are claimed in the claims and are explained in more detail below.

It is therefore advantageous if, in a (temporally subsequent) step, a targeted change in the opposite direction of the torque of the first electric machine, i.e., lowering or raising, is forced/induced.

It is also expedient if, in an additional (subsequent) step, the torque of the internal combustion engine is raised or lowered to a level intended for later use. This prevents jerking.

It is also beneficial for operation if an upper threshold value and a lower threshold value are defined for a differential speed between the first electric machine and the electric drive machine, and if the lower threshold value is undershot, a (previously) defined time increment is awaited until a clutch between the first shaft and the second shaft is engaged, and if the upper threshold value is exceeded, another adjustment of the speed of the first electric machine is forced.

An advantageous embodiment is also characterized in that (afterwards) at the same time a switching from a speed regulation of the first electric machine to a torque regulation of the first electric machine and a maintenance of the torque of the internal combustion engine and of the first electric machine are effected.

If (afterwards) the torque of the first electric machine is changed towards (or to) 0 Nm and (at the same time) the torque of the electric drive machine is changed in the opposite direction, particularly stable and efficient behavior is forced.

For wear-free operation, it is particularly recommended that the torque of the internal combustion engine is adjusted and also (at the same time) the torque of the electric drive machine is adjusted in the opposite direction in order to remove the entire torque used for drive from the internal combustion engine. This results in a high level of agility.

An advantageous embodiment is also characterized in that (afterwards) the actual states of the first electric machine, the electric drive machine and the internal combustion engine are monitored, and necessary torque changes are calculated by comparing with a target torque requested by the driver of the hybrid vehicle, a balancing of torques then being forced by changing the behavior of the electric drive machine.

The disclosure also relates to a computer program product designed to effect the method according to the disclosure.

Furthermore, the disclosure relates to a hybrid vehicle drive train with a control device that contains the computer program product.

### BRIEF DESCRIPTION OF THE DRAWINGS

The disclosure is explained in more detail below with the aid of drawings. In the drawings:

FIG. 1: shows a hybrid vehicle drive train according to the disclosure in layout,

FIGS. 2 and 3 show different embodiments of a control or regulation strategy for the method according to the disclosure,

FIG. 4 shows a detail resolution during the transition of the phrase 1 to phase 2 shown in FIGS. 2 and 3, and

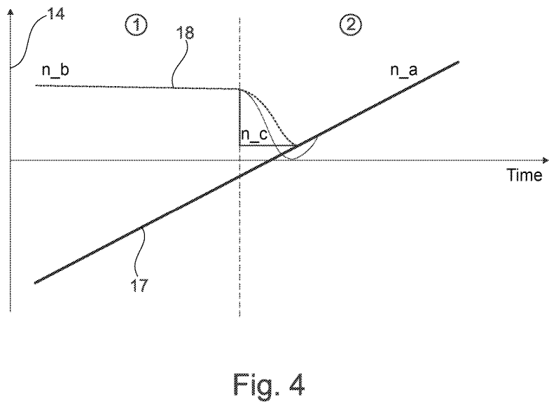

FIG. 5 shows a basic structure of the software architecture.

### DETAILED DESCRIPTION

The figures are only schematic in nature and serve only for understanding of the disclosure. Identical elements are provided with the same reference symbols.

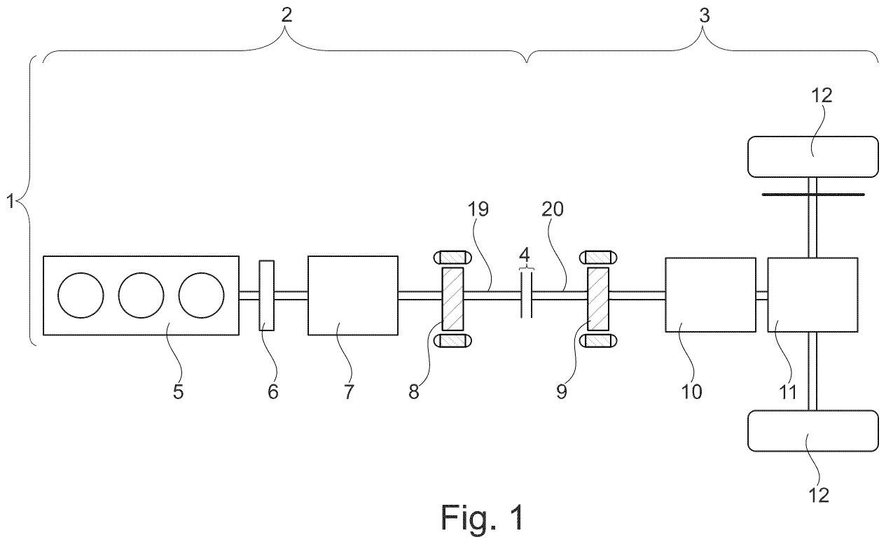

A hybrid vehicle drive train 1 according to the disclosure is shown in FIG. 1. The hybrid vehicle drive train 1 is divided into a first partial drive train 2 and a second partial drive train 3, with a clutch 4 being connected between them.

The first partial drive train 2 includes an internal combustion engine 5, a dual-mass flywheel 6, a first transmission 7 and a first electric machine 8. The second partial drive train 3 includes a second electric machine/electric drive machine 9, a second transmission 10 and a differential gearing 11 between two drive wheels 12.

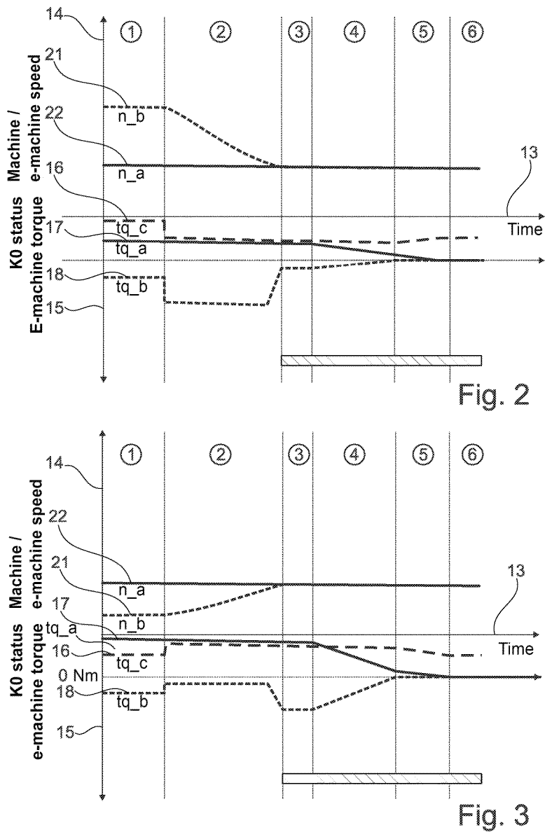

FIGS. 2 and 3 show the transient transition for coupling the two hybrid partial drive trains 2 and 3.

Phase 1 describes the decoupled drive train. n_a=the speed of the electric drive machine, i.e., the e-motor 2, n_b=the speed of the first electric machine, i.e., of the e-motor 1, tq_a=the e-motor 2 torque, tq_b=the e-motor 1 torque, and tq_c=the internal combustion engine torque.

In phase 2, the speeds of the two partial drive trains are synchronized at the clutch. As soon as n_b>n_a, the internal combustion engine torque is reduced so that synchronization can take place more quickly. If n_b<n_a, the internal combustion engine torque is increased to support synchronization. The maximum and current torques of the e-motor and internal combustion engine are always taken into account in order to achieve maximum performance and to support or limit the speed controller of the EM1. In the third phase it is checked that the synchronization is stable. As soon as the slip speed between EM1 and EM2 falls below a hysteresis threshold value, a counter is started. If the slip speed is within the hysteresis for a certain time period, the strategy switches further and issues a clutch engaging command. The speed controller is switched off and the torque of the EM1 is maintained. After the clutch is determined to be engaged, the strategy switches to torque blending phases 4 and 5. From then on, the torque distribution ensures that the torques in the drive train are distributed appropriately. For this purpose, all actual torques are monitored and the EM2 compensates for motor errors so that the driver's desired torque is applied to the wheel. Phases 4 and 5 are shown separately here for better illustration, but can also be combined. In phase 4, the EM1 torque gradient is suppressed to a limited degree and the torques are only regulated via the EM2, since this has a better degree of efficiency. In phase 5, the internal combustion engine torque is transferred to the hybrid strategy so that it moves to the strategically optimal point for the overall drive train.

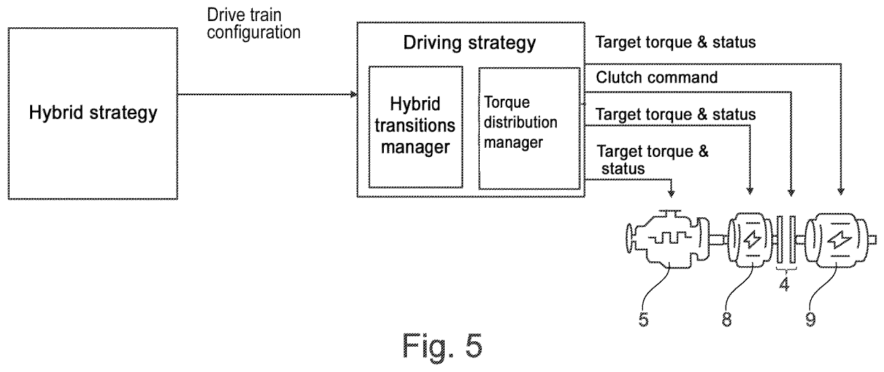

FIG. 5 shows the event chain of software from hybrid strategy to calculated torques. Based on the vehicle boundary conditions, the hybrid strategy calculates the future drive train target state and the associated torques and speeds for the internal combustion engine and e-motors. The driving strategy then decides, on the basis of the current driving state and the component boundary conditions, whether a transient process for coupling the partial drive train is triggered. The hybrid transition manager then controls the different phases of the transient process and passes the commands on to the torque distribution. This then ensures that the driver's desired torque is always set on the wheel.

FIG. 5 describes the target speed calculation for synchronizing the shafts before engaging the clutch. For this purpose, the current gradient of the e-motor 2 (n_a) speed is determined. Based on the differential speed and the gradient, a target speed (n_c) for e-motor 1 (n_b) is determined, which is then specified to the speed controller. The fastest possible adjustment of the target speed is thus determined without having to continuously adjust the target speed and causing undershooting, which extends the synchronization time.

In FIGS. 2 and 3, a total of six phases are plotted from left to right. In each diagram, time is given on the abscissa. The abscissa is referenced with reference symbol 13. On the ordinate referenced with reference symbol 14, the speed is given in the upper region and the torque in the lower region.

The torque curves of the internal combustion engine, electric drive machine 9 and the first electric machine 8 are plotted with reference symbols 16, 17 and 18.

It should be added that there is a first shaft 19 in the first partial drive train and a second shaft 20 in the second partial drive train. With reference symbols 21 and 22, the speed curves of the first shaft 19 and the second shaft 20 are referenced with reference symbols 21 and 22.

The same referencing is also chosen in FIG. 3.

The embodiments described above can be implemented as a computer program product, such as a storage medium, which is designed to carry out a method according to the preceding embodiments in cooperation with one or more computers, i.e., computer systems, or other computing units. The computer program product may be designed such that the method is executed after performing a predetermined routine, such as a setup routine.

The computer program product is designed, in cooperation with one or more computers, to carry out a method according to one of the preceding claims directly or, after carrying out a predetermined routine, indirectly/to form a device according to one of the preceding claims.

### LIST OF REFERENCE SYMBOLS

1 Hybrid vehicle drive train
2 First partial drive train
3 Second partial drive train
4 Clutch
5 Internal combustion engine
6 Dual-mass flywheel
7 First transmission
8 First electric machine/e-machine 1
9 Second electric machine/electric drive machine/e-machine 2
10 Second transmission
11 Differential gearing
12 Drive wheel
13 Time
14 Speed
15 Torque
16 Torque of the internal combustion engine
17 Torque of the electric drive machine
18 Torque of the first electric machine
19 First shaft
20 Second shaft
21 Speed of the first shaft
22 Speed of the second shaft

1. A method for coupling a first partial drive train of a hybrid vehicle having a first shaft, an internal combustion engine and a first electric machine that can be operated selectively in generator or motor mode to a second partial drive train of the hybrid vehicle having a second shaft and an electric drive machine, the method comprising: regulating a speed adjustment of the first shaft by acting on the speed of the first electric machine, at the same time a change in a torque of the internal combustion engine being carried out in the same direction in order to achieve the same performance level of the first shaft before the speed adjustment.

2. The method according to claim 1, wherein in one step a targeted change in the opposite direction of the torque of the first electric machine is forced.

3. The method according to claim 1, wherein in an additional step the torque of the internal combustion engine is increased or decreased to a level intended for later use.

4. The method according to claim 1, wherein an upper threshold value and a lower threshold value for a differential speed between the first electric machine and the electric drive machine are defined, wherein if the lower threshold value is undershot, a defined partial increment is awaited until a clutch between the first shaft and the second shaft is engaged, wherein if the upper threshold value is exceeded, another adjustment of the speed of the first electric machine is forced.

5. The method according to claim 1, wherein at the same time a switching from a speed regulation of the first electric machine to a torque regulation of the first electric machine and a maintenance of the torque of the internal combustion engine and of the first electric machine are effected.

6. The method according to claim 1, wherein the torque of the first electric machine is changed towards 0 Nm and the torque of the electric drive machine is changed in the opposite direction.

7. The method according to claim 1, wherein the torque of the internal combustion engine is adjusted and the torque of the electric drive machine is adjusted in the opposite direction in order to take the entire torque used for drive from the internal combustion engine.

8. The method according to claim 1, wherein actual states of the first electric machine, the electric drive machine and the internal combustion engine are monitored and necessary torque changes are calculated by comparing with a target torque requested by a driver of the hybrid vehicle, a balancing of torques then being forced by changing a behavior of the electric drive machine.

9. A computer program product designed to effect the method according to claim 1.

10. A hybrid vehicle drive train with a control device containing the computer program product according to claim 9.
